(19) United States
(12) Patent Application Publication
(10) Pub. No.: US 2025/0101872 A1
(43) Pub. Date: Mar. 27, 2025

(54) TURBINE ROTOR BLADE

(71) Applicant: MITSUBISHI HEAVY INDUSTRIES, LTD., Tokyo (JP)

(72) Inventors: Yoshifumi TSUJI, Tokyo (JP); Hidetoshi TAKEDA, Yokohama-shi, Kanagawa (JP); Kunihiko WAKI, Kakogawa-shi, Hyogo (JP)

(21) Appl. No.: 18/728,282

(22) PCT Filed: Jan. 18, 2023
(86) PCT No.: PCT/JP2023/001266

§ 371 Date: Jul. 11, 2024

(30) Foreign Application Priority Data
Jan. 19, 2022 (JP) 2022-006475

(51) Int. Cl. F01D 5/18; F01D 5/30

(52) U.S. Cl. CPC F01D 5/187; F01D 5/30; F05D 2200/11; F05D 2200/14; F05D 2240/304; F05D 2260/2214

(57) ABSTRACT

A turbine rotor blade according to at least one embodiment of the present disclosure comprises a blade root in which a first internal passage extending in a blade height direction is formed and a first opening on one-end side of the first internal passage is formed at the bottom, and an adjustment member attached to the bottom and having formed therein a first through hole overlapping the first opening when viewed from the blade height direction. The first through hole intersects with the first opening when viewed from the blade height direction, and has a first overlapping area that overlaps the first opening and a first non-overlapping area that does not overlap the first opening.

### TECHNICAL FIELD

The present disclosure relates to a turbine rotor blade.

The present application claims priority based on Japanese Patent Application No. 2022-006475 filed in Japan on Jan. 19, 2022, the contents of which are incorporated herein by reference.

### BACKGROUND ART

In an aviation or industrial gas turbine system, a high-temperature and high-pressure combustion gas is generated by mixing high-pressure air compressed by a compressor with fuel in a combustor and combusting the mixture, and the combustion gas is used as a working medium to drive a turbine, thereby converting thermal energy into kinetic energy. Therefore, a surface of a turbine rotor blade is exposed to the high-temperature working medium. In addition, in recent years, combustion temperature has been increasing to improve thermal efficiency of a gas turbine, creating a more severe temperature environment of the rotor blade. Therefore, convection cooling, film cooling, or the like is performed to suppress high-temperature corrosion of a rotor blade material or a decrease in structural strength (for example, refer to PTL 1).

### CITATION LIST

### Patent Literature

[PTL 1] Japanese Patent No. 5953136

### SUMMARY OF INVENTION

### Technical Problem

For example, in a turbine rotor blade disclosed in PTL 1, a flow rate of cooling air supplied to a cooling channel which is an internal passage in a rotor blade can be adjusted by an orifice at a bottom portion of a rotor blade root.

Meanwhile, since the turbine rotor blade is manufactured by casting, a positional deviation between the internal passage and an opening of the orifice is relatively likely to occur. Therefore, there is a concern that an overlapping region between an opening of the internal passage and the opening of the orifice when viewed from a rotor blade height direction may be unintentionally reduced, and a desired flow rate of the cooling air may not be obtained.

At least one embodiment of the present disclosure has been made in view of the above circumstances, and an object of the embodiment is to provide a turbine rotor blade capable of supplying cooling air having a desired flow rate to an inside of a rotor blade.

### Solution to Problem

(1) A turbine rotor blade according to at least one embodiment of the present disclosure includes
a rotor blade root in which a first internal passage that extends in a rotor blade height direction is formed and a first opening on one end side of the first internal passage is formed at a bottom portion, and
an adjustment member which is attached to the bottom portion and in which a first through-hole that overlaps with the first opening is formed when viewed from the rotor blade height direction,
in which, when viewed from the rotor blade height direction, the first through-hole intersects with the first opening, and has a first overlapping region that overlaps with the first opening, and a first non-overlapping region that does not overlap with the first opening.

### Advantageous Effects of Invention

According to at least one embodiment of the present disclosure, cooling air having a desired flow rate can be supplied to an inside of a rotor blade.

### BRIEF DESCRIPTION OF DRAWINGS

FIG. 1 is an internal sectional view of an example of a turbine rotor blade according to some embodiments.

FIG. 2 is an internal sectional view of another example of the turbine rotor blade according to some embodiments.

FIG. 3 is a schematic view when an adjustment member according to one embodiment is viewed from a rotor blade root side toward a tip side of a rotor blade body along a rotor blade height direction.

FIG. 4A is a schematic view when a first through-hole and a first opening according to the embodiment are viewed from the rotor blade root side toward the tip side of the rotor blade body along the rotor blade height direction.

FIG. 4B is a schematic view when a first through-hole and a first opening according to another embodiment are viewed from the rotor blade root side toward the tip side of the rotor blade body along the rotor blade height direction.

FIG. 5A is a view for describing a case where an area of a through-hole and an area of an internal passage opening are relatively similar to each other.

FIG. 5B is a view for describing the case where the area of the through-hole and the area of the internal passage opening are relatively similar to each other.

FIG. 6 is a view illustrating another example of the through-hole and the internal passage opening.

### DESCRIPTION OF EMBODIMENTS

Hereinafter, some embodiments of the present disclosure will be described with reference to the accompanying drawings. Dimensions, materials, shapes, relative arrangements, and the like of components described as embodiments or illustrated in the drawings are not intended to limit the scope of the present disclosure, but are merely explanatory examples.

For example, an expression representing a relative or absolute arrangement such as “in a certain direction”, “along a certain direction”, “parallel”, “orthogonal”, “center”, “concentric”, or “coaxial” does not strictly represent only such an arrangement, but also a tolerance or a state of being relatively displaced with an angle or a distance to the extent that the same function can be obtained.

For example, expressions such as “identical”, “equal”, and “homogeneous”, which indicate that things are in the same state, not only represent a state of being strictly equal, but also represent a state in which there is a tolerance, or a difference to the extent that the same function can be obtained.

For example, an expression indicating a shape such as a square shape or a cylindrical shape not only represents a shape such as a square shape or a cylindrical shape in a geometrically strict sense, but also represents a shape that includes concave and convex portions, chamfered portions, or the like to the extent that the same effects can be obtained.

Meanwhile, an expression such as “comprising”, “possessing”, “provided with”, “including”, or “having” one component is not an exclusive expression excluding the presence of other components.

### Outline of Turbine Rotor Blade

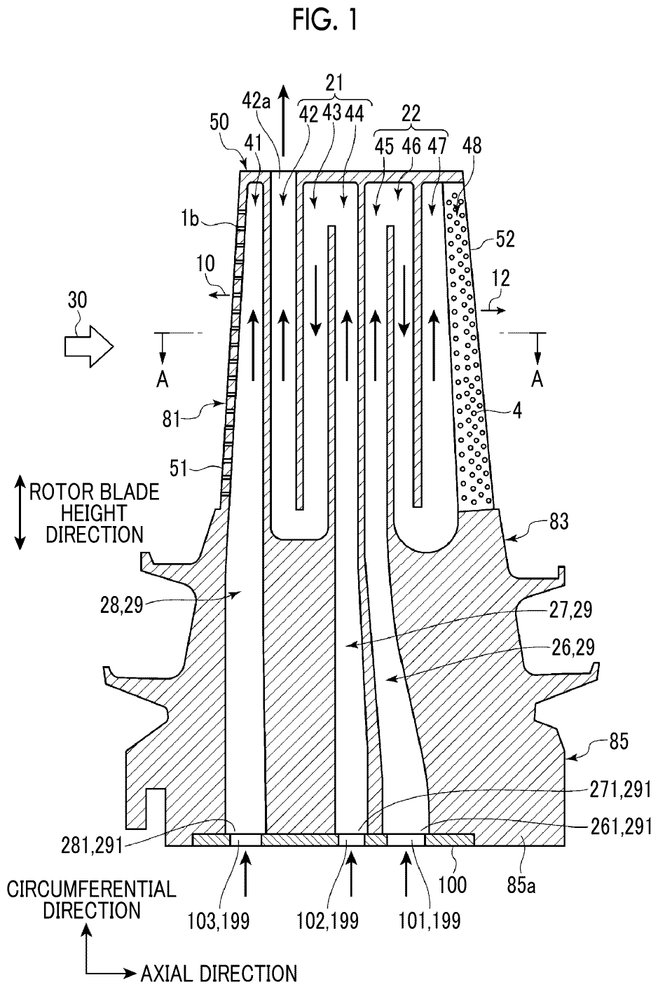

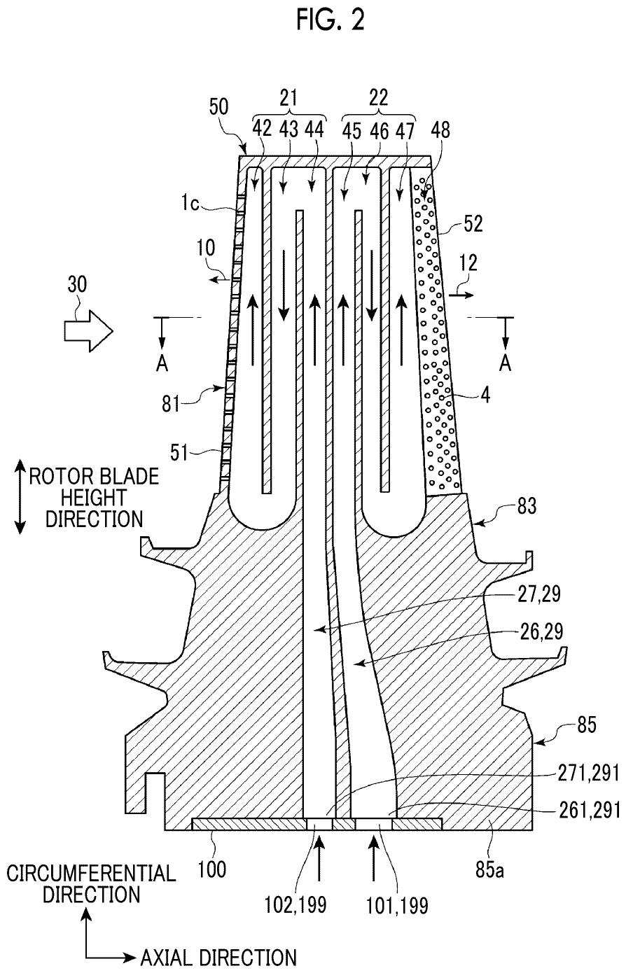

A cooling structure of a turbine rotor blade according to some embodiments of the present disclosure will be described with reference to FIGS. 1 and 2. FIG. 1 is an internal sectional view of an example of the turbine rotor blade according to some embodiments, and illustrates a cross section along a rotor blade height direction. FIG. 2 is an internal sectional view of another example of the turbine rotor blade according to some embodiments, and illustrates the cross section along the rotor blade height direction.

A turbine rotor blade 50 according to some embodiments is a turbine rotor blade of a gas turbine, and includes a rotor blade body 81, a platform 83, and a rotor blade root portion (rotor blade root) 85. The rotor blade root 85 is embedded in a rotor of the gas turbine (not illustrated), and the turbine rotor blade 50 rotates together with the rotor. The platform 83 is integrally configured with the rotor blade root 85.

The turbine rotor blade 50 according to some embodiments includes, as illustrated in FIGS. 1 and 2, a meandering channel (front edge side meandering channel 21) that extends from a rotor blade center portion toward a front edge 51 while meandering, and a meandering channel (rear edge side meandering channel 22) that extends from the rotor blade center portion toward a rear edge 52 while meandering. The turbine rotor blade 50 illustrated in FIG. 1 further includes a front edge side channel 41 provided on a front edge 51 side with respect to the front edge side meandering channel 21. In the turbine rotor blade 50 according to some embodiments, the front edge side meandering channel 21, the rear edge side meandering channel 22, and the front edge side channel 41 are independent channels of each other.

In the turbine rotor blade 50 according to some embodiments, for example, six cooling channels 42 to 47 that are channels constituting the front edge side meandering channel 21 and the rear edge side meandering channel 22 are provided in order from the front edge 51 side, and a cooling channel 48 in which a large number of pin fins 4 are provided is provided on a rearmost edge side.

The turbine rotor blade 50 illustrated in FIG. 1 includes a front edge film cooling hole 1b that is open to the front edge 51 as a film cooling hole for blowing out film cooling air. For example, the front edge film cooling hole 1b is connected to the front edge side channel 41.

The turbine rotor blade 50 illustrated in FIG. 2 includes a front edge film cooling hole 1c that is open to the front edge 51 as the film cooling hole for blowing out the film cooling air. For example, the front edge film cooling hole 1c is connected to the cooling channel 42.

In the turbine rotor blade 50 according to some embodiments, the cooling channel 42, the cooling channel 43, and the cooling channel 44 that are provided in order from a front edge side are sequentially connected to each other to constitute the meandering channel (front edge side meandering channel 21) that extends from the rotor blade center portion toward the front edge 51 while meandering. In addition, the cooling channel 45, the cooling channel 46, and the cooling channel 47 constitute the meandering channel (rear edge side meandering channel 22) that is sequentially connected toward the rear edge 52.

The turbine rotor blade 50 according to some embodiments includes a first internal passage 26, a second internal passage 27, and a third internal passage 28 that extend in the rotor blade height direction, that is, in a radial direction of the rotor of the gas turbine, from a bottom portion 85a of the rotor blade root 85.

The first internal passage 26 is an internal passage connected to the cooling channel 45 constituting the rear edge side meandering channel 22, and a first opening 261 which is an opening on one end side (inlet side) is formed at the bottom portion 85a of the rotor blade root 85.

The second internal passage 27 is an internal passage connected to the cooling channel 44 constituting the front edge side meandering channel 21, and a second opening 271 which is an opening on one end side (inlet side) is formed at the bottom portion 85a of the rotor blade root 85.

The third internal passage 28 is an internal passage connected to the front edge side channel 41, and a third opening 281 which is an opening on one end side (inlet side) is formed at the bottom portion 85a of the rotor blade root 85.

The turbine rotor blade 50 according to some embodiments includes an adjustment member 100 attached to the bottom portion 85a of the rotor blade root 85.

The adjustment member 100 is a plate-shaped member for adjusting a flow rate of cooling air serving as a cooling medium flowing into the first internal passage 26, the second internal passage 27, and the third internal passage 28, and a first through-hole 101, a second through-hole 102, and a third through-hole 103 that penetrate an adjustment member are formed in a thickness direction of the plate, that is, in the rotor blade height direction.

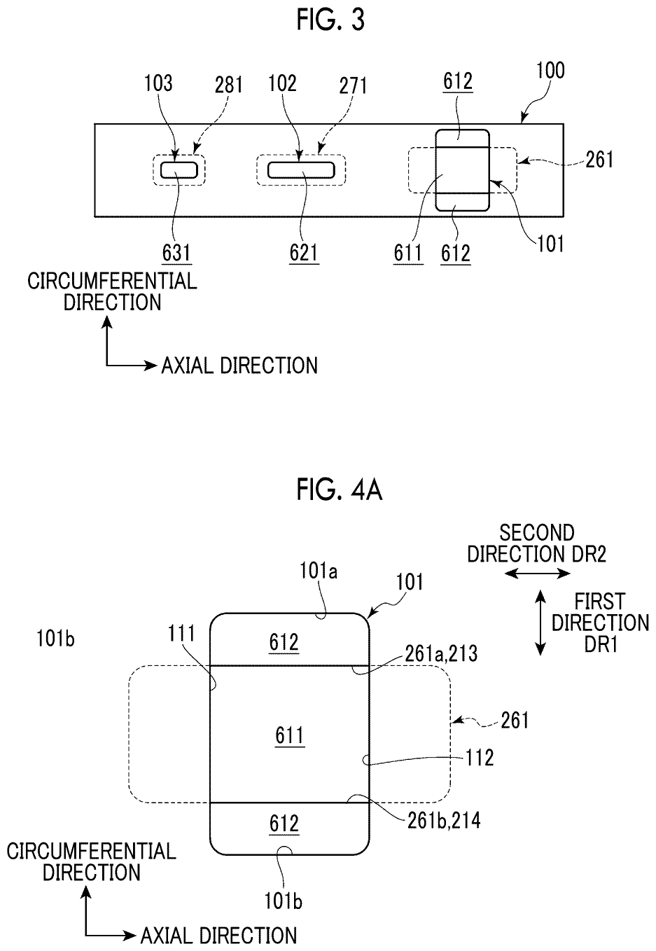

FIG. 3 is a schematic view of the turbine rotor blade 50 illustrated in FIG. 1 when the adjustment member 100 attached to the rotor blade root 85 is viewed from a rotor blade root 85 side toward a tip 81a side of the rotor blade body 81 along the rotor blade height direction. As illustrated in FIG. 3, the first through-hole 101 overlaps with the first opening 261 when viewed from the rotor blade height direction. Similarly, the second through-hole 102 overlaps with the second opening 271 when viewed from the rotor blade height direction. The third through-hole 103 overlaps with the third opening 281 when viewed from the rotor blade height direction. The turbine rotor blade 50 illustrated in FIG. 2 is the same as in the schematic view illustrated in FIG. 3 except that the third through-hole 103 and the third opening 281 in FIG. 3 are not provided, and thus the illustration thereof is omitted.

The first through-hole 101 functions as an orifice for adjusting the flow rate of the cooling air flowing into the first internal passage 26. Similarly, the second through-hole 102 functions as an orifice for adjusting the flow rate of the cooling air flowing into the second internal passage 27. The third through-hole 103 functions as an orifice for adjusting the flow rate of the cooling air flowing into the third internal passage 28. When a flow rate test of the cooling air is performed to adjust an opening area of each of the through-holes 101, 102, and 103, cooling air having a flow rate required for each of the cooling channels can flow therethrough.

As illustrated in FIG. 1, the front edge side channel 41 and the third internal passage 28 extend from the third opening 281, which is an intake port of cooling air in a lower portion of a rotor blade, to a rotor blade tip, and do not form a meandering channel. Therefore, a pressure loss of the entire channel is small. Therefore, even at the front edge 51 having a high combustion gas pressure, the cooling air can be supplied at a pressure at which a combustion gas 30 does not flow back from the front edge film cooling hole 1b.

In the front edge e side meandering channel 21 positioned behind the front edge side channel 41, cooling air supplied from the second opening 271 serving as the intake port of the cooling air flows from the cooling channel 44 toward the cooling channel 42 via the cooling channel 43, that is, toward the front edge 51. The cooling channel 43 and the cooling channel 42 are connected to each other at the rotor blade root portion. Meanwhile, in the rear edge side meandering channel 22 positioned behind the rotor blade, the cooling air supplied from the first opening 261 serving as the intake port of the cooling air flows from the cooling channel 45 toward the cooling channel 48 via the cooling channel 46 and the cooling channel 47 in order, that is, toward the rear edge 52. The cooling air is blown out as rear edge blown-out air 12 from the cooling channel 48 provided with the large number of pin fins 4.

As illustrated in FIG. 1, the cooling air that has flowed through the front edge side meandering channel 21 is discharged to an outside of the rotor blade body 81 from an opening 42a of the cooling channel 42 provided at a tip portion of the rotor blade body 81.

As illustrated in FIG. 2, the cooling air that has flowed through the front edge side meandering channel 21 is blown out from the film cooling hole 1c provided in the cooling channel 42 to cool a rotor blade suction side from the outside.

### About Relationship Between First Through-Hole 101 and First Opening 261

In the turbine rotor blade 50 according to some embodiments, on a rear edge 52 side with respect to a maximum rotor blade thickness position, a distance between a pressure-side wall surface 53 and a suction-side wall surface 54 decreases toward the rear edge 52, and a thickness of the rotor blade body 81 decreases. Therefore, also in the cooling channel formed inside the rotor blade body 81, on the rear edge 52 side with respect to the maximum rotor blade thickness position, the cooling channel on the rear edge 52 side tends to have a channel width in a thickness direction of the rotor blade body 81 narrower than that of the cooling channel on front edge 51 side. In addition, since a plurality of the cooling channels 42 to 47 are provided in the rotor blade body 81 from the front edge 51 side to the rear edge 52 side, it is difficult to increase the channel width along a camber line of the rotor blade body 81 in each of the cooling channels 42 to 47.

In the turbine rotor blade 50 according to some embodiments, since the rear edge side meandering channel 22 formed on the rear edge 52 side is a meandering channel, a pressure loss tends to be larger than that of a non-meandering channel (front edge side channel 41). Therefore, for example, in the turbine rotor blade 50 according to some embodiments described above, the rear edge side meandering channel 22 is less likely to allow the cooling air to flow as compared to other channels (front edge side channel 41 and front edge side meandering channel 21).

Therefore, in the turbine rotor blade 50 according to some embodiments, a restriction of the cooling air flowing into the first internal passage 26 via the first through-hole 101 tends to be mild as compared with a restriction of the cooling air flowing into the second internal passage 27 via the second through-hole 102 or a restriction of the cooling air flowing into the third internal passage 28 via the third through-hole 103.

That is, in the turbine rotor blade 50 according to some embodiments, an area of the first through-hole 101 when viewed from the rotor blade height direction is similar to an area of the first opening 261 when viewed from the rotor blade height direction, in comparison with, when viewed from the rotor blade height direction, a relationship between an area of the second through-hole 102 and an area of the second opening 271 and a relationship between an area of the third through-hole 103 and an area of the third opening 281.

In the following description, when there is no need to particularly distinguish the first internal passage 26, the second internal passage 27, and the third internal passage 28 or when these are collectively referred to, when these are described as internal passages formed inside the turbine rotor blade, like the respective internal passages 26, 27, and 28, these are simply referred to as an internal passage 29, and an opening on one end side (inlet side) of the internal passage 29 is referred to as an internal passage opening 291.

Similarly, in the following description, when there is no need to particularly distinguish the first through-hole 101, the second through-hole 102, and the third through-hole 103 or when these are collectively referred to, when these are described as through-holes serving as orifices for the internal passage 29 similarly to the respective through-holes 101, 102, and 103, these are simply referred to as a through-hole 199.

In addition, in the following description, when an area is simply referred to for the first through-hole 101, the second through-hole 102, the third through-hole 103, and the through-hole 199, the area represents an area when viewed from the rotor blade height direction.

Similarly, in the following description, when an area is simply referred to for the first internal passage 26, the second internal passage 27, the third internal passage 28, and the internal passage 29, the area represents the area when viewed from the rotor blade height direction.

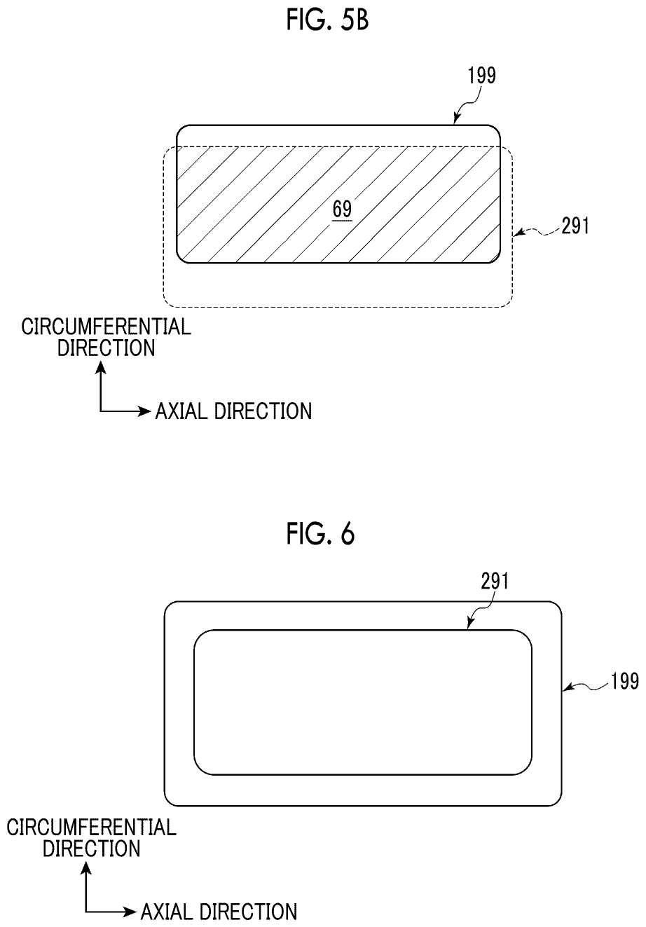

FIGS. 5A and 5B are views for describing the case where the area of the through-hole 199 and an area of the internal passage opening 291 are relatively similar to each other. FIGS. 5A and 5B are schematic views when viewed from the rotor blade root 85 side toward the tip 81a side of the rotor blade body 81 along the rotor blade height direction. FIG. 5A illustrates a case where there is no deviation at a relative position between the through-hole 199 and the internal passage opening 291, and FIG. 5B illustrates an example of a case where there is a deviation at the relative position between the through-hole 199 and the internal passage opening 291.

The cooling air passes through an overlapping region 69 between the through-hole 199 and the internal passage opening 291 when viewed from the rotor blade height direction. Therefore, when the through-hole 199 unintentionally protrudes to an outer side of the internal passage opening 291 when viewed from the rotor blade height direction, an area of the overlapping region 69 unintentionally decreases.

As illustrated in FIGS. 5A and 5B, in a case where the area of the through-hole 199 and the area of the internal passage opening 291 are relatively similar to each other, even when the deviation at the relative position between the through-hole 199 and the internal passage opening 291 is relatively small, the through-hole 199 is likely to unintentionally protrude to the outer side of the internal passage opening 291 when viewed from the rotor blade height direction.

Therefore, in a case where the area of the through-hole 199 and the area of the internal passage opening 291 are relatively similar to each other, even when the deviation at the relative position between the through-hole 199 and the internal passage opening 291 is relatively small, the area of the overlapping region 69 is likely to be unintentionally reduced.

Therefore, in a case where the area of the through-hole 199 and the area of the internal passage opening 291 are relatively similar to each other, a flow rate of the cooling air is likely to be unintentionally reduced.

As described above, in the turbine rotor blade 50 according to some embodiments, the area of the first through-hole 101 and the area of the first opening 261 are similar to each other. Therefore, the flow rate of the cooling air is likely to be unintentionally reduced due to a deviation at a relative position between the first through-hole 101 and the first opening 261.

In addition, since the turbine rotor blade is generally manufactured by precision casting, it is difficult to secure accuracy of a position of the internal passage 29 to a certain degree or more without performing machining.

Therefore, in the turbine rotor blade 50 according to some embodiments, the unintended decrease in the area of the overlapping region 69 is suppressed as follows.

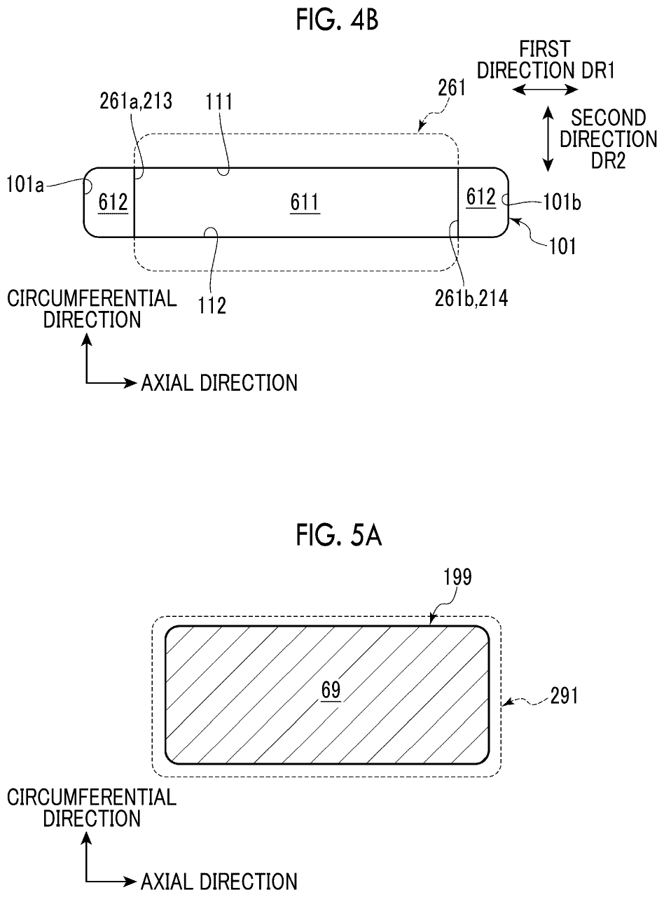

FIG. 4A is a schematic view when the first through-hole 101 and the first opening 261 according to the embodiment are viewed from the rotor blade root 85 side toward the tip 81a side of the rotor blade body 81 along the rotor blade height direction.

FIG. 4B is a schematic view when the first through-hole 101 and the first opening 261 according to another embodiment are viewed from the rotor blade root 85 side toward the tip 81a side of the rotor blade body 81 along the rotor blade height direction.

As illustrated in FIGS. 3, 4A, and 4B, in the turbine rotor blade 50 according to some embodiments, the first through-hole 101, the second through-hole 102, and the third through-hole 103 have a rectangular shape in which four corners are chamfered roundly when viewed from the rotor blade height direction.

Each of the through-holes 101, 102, and 103 may have four sides that linearly extend when viewed from the rotor blade height direction. Accordingly, a flow rate can be easily adjusted in each of the through-holes 101, 102, and 103.

Each of the through-holes 101, 102, and 103 may have a rectangular shape or a square shape in which the adjacent sides are orthogonal to each other when viewed from the rotor blade height direction. In the rectangular shape or the square shape, the four corners may be chamfered roundly.

In the case where each of the through-holes 101, 102, and 103 has two sides extending in a lateral direction and two sides extending in a longitudinal direction, like the rectangular shape, the side extending in the lateral direction may be, for example, a curved line such as an arc.

In FIG. 4A, the longitudinal direction of the first through-hole 101 is a circumferential direction of the rotor of the gas turbine, and the lateral direction of the first through-hole 101 is an axial direction of the rotor of the gas turbine.

In FIG. 4B, the longitudinal direction of the first through-hole 101 is the axial direction of the rotor of the gas turbine, and the lateral direction of the first through-hole 101 is the circumferential direction of the rotor of the gas turbine.

As illustrated in FIG. 3, the longitudinal direction of the second through-hole 102 and the third through-hole 103 is the axial direction of the rotor of the gas turbine, and the lateral direction of the second through-hole 102 and the third through-hole 103 is the circumferential direction of the rotor of the gas turbine.

In the following description, the circumferential direction of the rotor of the gas turbine is also simply referred to as a circumferential direction. Similarly, in the following description, the axial direction of the rotor of the gas turbine is also simply referred to as an axial direction, and the radial direction of the rotor of the gas turbine is also simply referred to as a radial direction.

As illustrated in FIGS. 4A and 4B, the first through-hole 101 intersects with the first opening 261 when viewed from the rotor blade height direction. This feature is referred to as a feature A1.

The first through-hole 101 illustrated in FIGS. 4A and 4B includes a first overlapping region 611 that overlaps with the first opening 261, and a first non-overlapping region 612 that does not overlap with the first opening 261, when viewed from the rotor blade height direction. This feature is referred to as a feature A2. In addition, the features A1 and A2 are collectively referred to as a feature A.

As described above, the cooling air for cooling the turbine rotor blade 50 passes through the first overlapping region 611.

In the turbine rotor blade 50 according to some embodiments, since the first non-overlapping region 612 is present, even when a deviation at the positions of the first opening 261 and the first through-hole 101 occurs such that a distance between an edge portion (first edge portion 101a and second edge portion 101b) of the first through-hole 101 and an edge portion (third edge portion 261a and fourth edge portion 261b) of the first opening 261 changes, which define the first non-overlapping region 612, it is possible to suppress a change in an area of the first overlapping region 611 when viewed from the rotor blade height direction. Accordingly, even when the positional deviation of the first through-hole 101 with respect to the first opening 261 occurs, a decrease in the flow rate of the cooling air can be suppressed, and a desired flow rate of the cooling air can be secured.

As illustrated in FIG. 3, in the turbine rotor blade 50 according to some embodiments, the second through-hole 102 and the third through-hole 103 may be arranged to be positioned inside the second opening 271 and the third opening 281.

As illustrated in FIGS. 4A and 4B, the first through-hole 101 is larger than the first opening 261 in a first direction Dr1 when viewed from the rotor blade height direction. This feature is referred to as a feature B1.

As illustrated in FIGS. 4A and 4B, the first through-hole 101 has the first non-overlapping region 612 on one side and the other side in the first direction Dr1 when viewed from the rotor blade height direction. This feature is referred to as a feature B2. In addition, the features B1 and B2 are collectively referred to as a feature B.

In the first through-hole 101 illustrated in FIG. 4A, the first direction Dr1 is the circumferential direction. In addition, in the first through-hole 101 illustrated in FIG. 4B, the first direction Dr1 is the axial direction.

Since the first non-overlapping region 612 is present on the one side and the other side in the first direction Dr1, even when the position of the first opening 261 and the position of the first through-hole 101 are deviated in any direction of the one side and the other side in the first direction Dr1, the change in the area of the first overlapping region 611 when viewed from the rotor blade height direction can be suppressed. Accordingly, even when the position of the first opening 261 and the position of the first through-hole 101 are deviated in any direction on the one side and the other side in the first direction Dr1, the decrease in the flow rate of the cooling air can be suppressed, and the desired flow rate of the cooling air can be secured.

In the first through-hole 101 illustrated in FIG. 4A, the first direction Dr1 is a lateral direction of the first opening 261 when viewed from the rotor blade height direction, that is, the circumferential direction. In other words, the first through-hole 101 illustrated in FIG. 4A is larger than the first opening 261 in the circumferential direction. This feature is referred to as a feature B1a included in the feature B1.

Accordingly, even when the position of the first opening 261 and the position of the first through-hole 101 are deviated in any direction on the one side and the other side in the lateral direction (circumferential direction) of the first opening 261, the decrease in the flow rate of the cooling air can be suppressed, and the desired flow rate of the cooling air can be secured.

In the first through-hole 101 illustrated in FIG. 4B, the first direction Dr1 is a longitudinal direction of the first opening 261 when viewed from the rotor blade height direction, that is, the axial direction. In other words, the first through-hole 101 illustrated in FIG. 4B is larger than the first opening 261 in the axial direction. This feature is referred to as a feature B1b included in the feature B1.

Accordingly, even when the position of the first opening 261 and the position of the first through-hole 101 are deviated in any direction on the one side and the other side in the longitudinal direction (axial direction) of the first opening 261, the decrease in the flow rate of the cooling air can be suppressed, and the desired flow rate of the cooling air can be secured.

In the first through-hole 101 illustrated in FIGS. 4A and 4B, when viewed from the rotor blade height direction, the first through-hole 101 is defined by a first side 111 that extends along the first direction Dr1 and a second side 112 that is separated from the first side 111 in a second direction Dr2 intersecting with the first direction Dr1 and that is parallel to the first side 111. This feature is referred to as a feature C.

In the first through-hole 101 illustrated in FIGS. 4A and 4B, the second direction Dr2 is a direction orthogonal to the first direction Dr1. However, the second direction Dr2 may be inclined with respect to a direction orthogonal to the first direction Dr1.

Accordingly, even when the position of the first opening 261 and the position of the first through-hole 101 are deviated in any direction of the one side and the other side in the first direction Dr1, a distance between the first side 111 and the second side 112 in the first overlapping region 611 does not change. Therefore, the change in the area of the first overlapping region 611 when viewed from the rotor blade height direction can be suppressed. Accordingly, even when the position of the first opening 261 and the position of the first through-hole 101 are deviated in any direction on the one side and the other side in the first direction Dr1, the decrease in the flow rate of the cooling air can be suppressed, and the desired flow rate of the cooling air can be secured.

In the first through-hole 101 illustrated in FIGS. 4A and 4B, when viewed from the rotor blade height direction, the first opening 261 is defined by a third side 213 that extends along the second direction Dr2 intersecting with the first direction Dr1 and a fourth side 214 that is separated from the third side 213 in the first direction Dr1 and that is parallel to the third side 213. This feature is referred to as a feature D.

Accordingly, even when the position of the first opening 261 and the position of the first through-hole 101 are deviated in any direction of one side and the other side in the second direction Dr2, a distance between the third side 213 and the fourth side 214 in the first overlapping region 611 does not change. Therefore, the change in the area of the first overlapping region 611 when viewed from the rotor blade height direction can be suppressed. Accordingly, even when the position of the first opening 261 and the position of the first through-hole 101 are deviated in any direction on the one side and the other side in the second direction Dr2, the decrease in the flow rate of the cooling air can be suppressed, and the desired flow rate of the cooling air can be secured.

In the turbine rotor blade 50 according to some embodiments, as illustrated in FIG. 3, the rotor blade root 85 may be provided with the second internal passage 27 extending in the rotor blade height direction, and the second opening 271 that is an opening on the one end side (inlet side) of the second internal passage 27 may be formed at the bottom portion 85a. In the adjustment member 100, a second through-hole 102 that overlaps with the second opening 271 when viewed d from the rotor blade height direction may be formed. When viewed from the rotor blade height direction, the second through-hole 102 has a second overlapping region 621 that overlaps with the second opening 271.

Accordingly, the cooling air can be supplied to the second internal passage 27 different from the first internal passage 26, so that the turbine rotor blade 50 can be further cooled.

As illustrated in FIG. 3, in the turbine rotor blade 50 according to some embodiments, the first opening 261 and the first through-hole 101 are positioned closer to the rear edge 52 side of the rotor blade body 81 than the second opening 271 and the second through-hole 102 are.

Therefore, the area of the first through-hole 101 when viewed from the rotor blade height direction is similar to the area of the first opening 261 when viewed from the rotor blade height direction, in comparison with, when viewed from the rotor blade height direction, the relationship between the area of the second through-hole 102 and the area of the second opening 271. Therefore, in order to suppress an unintended decrease in the flow rate of the cooling air passing through the first overlapping region 611, the first through-hole 101 and the first opening 261 may have the feature A as described above, and may further have at least one of the features B, C, and D.

Since the first through-hole 101 and the first opening 261 illustrated in FIGS. 4A and 4B have the above-described features, it is easy to secure the desired flow rate of cooling air in the first opening 261 and the first through-hole 101 which are more likely to be affected by a change at positions of an opening and a through-hole than the second opening 271 and the second through-hole 102.

In the first through-hole 101 illustrated in FIGS. 4A and 4B, a value (S1a/S1b) obtained by dividing an area (S1a) of the first overlapping region 611 when viewed from the rotor blade height direction by an area (S1b) of the first opening 261 when viewed from the rotor blade height direction is larger than a value (S2a/S2b) obtained by dividing an area (S2a) of the second overlapping region 621 when viewed from the rotor blade height direction by an area (S2b) of the second opening 271 when viewed from the rotor blade height direction.

As described above, in the turbine rotor blade 50 according to some embodiments, the restriction of the cooling air flowing into the first internal passage 26 via the first through-hole 101 tends to be mild as compared with the restriction of the cooling air flowing into the second internal passage 27 via the second through-hole 102 or the restriction of the cooling air flowing into the third internal passage 28 via the third through-hole 103. Therefore, a ratio of the area (S1a) of the first overlapping region 611 to the area (S1b) of the first opening 261, that is, the value (S1a/S1b) obtained by dividing the area (S1a) of the first overlapping region 611 by the area (S1b) of the first opening 261, is larger than the value (S2a/S2b) obtained by dividing the area (S2a) of the second overlapping region 621 by the area (S2b) of the second opening 271.

As a value (Sa/Sb) obtained by dividing an area Sa of the overlapping region 69 by an area Sb of the internal passage opening 291 increases, when the positions of the internal passage opening 291 and the through-hole 199 are deviated, the through-hole 199 is likely to unintentionally protrude to the outer side of the internal passage opening 291 when viewed from the rotor blade height direction.

That is, as the above value (Sa/Sb) increases, the area of the overlapping region 69 is likely to change unintentionally, and the flow rate of the cooling air flowing through the overlapping region 69 is likely to decrease unintentionally.

In the first through-hole 101 illustrated in FIGS. 3, 4A, and 4B, the value (S1a/S1b) obtained by dividing the area (S1a) of the first overlapping region 611 by the area (S1b) of the first opening 261 is larger than the value (S2a/S2b) obtained by dividing the area (S2a) of the second overlapping region 621 by the area (S2b) of the second opening 271. Therefore, for example, in a case where the first through-hole 101 and the first opening 261 do not have the above-described features A, B, C, and D as in the through-hole 199 and the internal passage opening 291 illustrated in FIG. 5A, the area (S1a) of the first overlapping region 611 is likely to change unintentionally as compared with that of the second overlapping region 621, and the flow rate of the cooling air flowing through the overlapping region 69 is likely to decrease unintentionally.

In order to suppress the unintended decrease in the flow rate of the cooling air passing through the first overlapping region 611, the first through-hole 101 and the first opening 261 may have the feature A as described above, and may further have at least one of the features B, C, and D.

Since the first through-hole 101 and the first opening 261 illustrated in FIGS. 3, 4A, and 4B have the above-described features, it is easy to secure the desired flow rate of cooling air in the first opening 261 and the first through-hole 101 which are more likely to be affected by the change at the positions of the opening and the through-hole than the second opening 271 and the second through-hole 102.

In the turbine rotor blade 50 according to some embodiments, as illustrated in FIG. 3, the rotor blade root 85 may be provided with the third internal passage 28 extending in the rotor blade height direction, and the third opening 281 that is an opening on the one end side (inlet side) of the third internal passage 28 may be formed at the bottom portion 85a. In the adjustment member 100, a third through-hole 103 that overlaps with the third opening 281 when viewed from the rotor blade height direction may be formed. When viewed from the rotor blade height direction, the third through-hole 103 has a third overlapping region 631 that overlaps with the third opening 281.

Accordingly, the cooling air can be supplied to the third internal passage 28 different from the first internal passage 26 and the second internal passage 27, so that the turbine rotor blade 50 can be more cooled.

As illustrated in FIG. 3, in the turbine rotor blade 50 according to some embodiments, the first opening 261 and the first through-hole 101 are positioned closer to the rear edge 52 side of the rotor blade body 81 than the second opening 271, the second through-hole 102, the third opening 281, and the third through-hole 103 are.

Therefore, the area of the first through-hole 101 when viewed from the rotor blade height direction is similar to the area of the first opening 261 when viewed from the rotor blade height direction, in comparison with, when viewed from the rotor blade height direction, the relationship between the area of the second through-hole 102 and the area of the second opening 271 and the relationship between the area of the third through-hole 103 and the area of the third opening 281. Therefore, in order to suppress an unintended decrease in the flow rate of the cooling air passing through the first overlapping region 611, the first through-hole 101 and the first opening 261 may have the feature A as described above, and may further have at least one of the features B, C, and D.

Since the first through-hole 101 and the first opening 261 illustrated in FIGS. 4A and 4B have the above-described features, it is easy to secure the desired flow rate of cooling air in the first opening 261 and the first through-hole 101 which are more likely to be affected by the change at the positions of the opening and the through-hole than the second opening 271 and the second through-hole 102 or the third opening 281 and the third through-hole 103.

In the first through-hole 101 illustrated in FIGS. 4A and 4B, the value (S1a/S1b) obtained by dividing the area (S1a) of the first overlapping region 611 when viewed from the rotor blade height direction by the area (S1b) of the first opening 261 when viewed from the rotor blade height direction is larger than the value (S2a/S2b) obtained by dividing the area (S2a) of the second overlapping region 621 when viewed from the rotor blade height direction by the area (S2b) of the second opening 271 when viewed from the rotor blade height direction and a value (S3a/S3b) obtained by dividing an area (S3a) of the third overlapping region 631 when viewed from the rotor blade height direction by an area (S3b) of the third opening 281 when viewed from the rotor blade height direction.

As described above, in the turbine rotor blade 50 according to some embodiments, the restriction of the cooling air flowing into the first internal passage 26 via the first through-hole 101 tends to be mild as compared with the restriction of the cooling air flowing into the second internal passage 27 via the second through-hole 102 or the restriction of the cooling air flowing into the third internal passage 28 via the third through-hole 103. Therefore, the ratio of the area (S1a) of the first overlapping region 611 to the area (S1b) of the first opening 261, that is, the value (S1a/S1b) obtained by dividing the area (S1a) of the first overlapping region 611 by the area (S1b) of the first opening 261, is larger than the value (S2a/S2b) obtained by dividing the area (S2a) of the second overlapping region 621 by the area (S2b) of the second opening 271 or the value (S3a/S3b) obtained by dividing the area (S3a) of the third overlapping region 631 by the area (S3b) of the third opening 281. Therefore, the area (S1a) of the first overlapping region 611 is likely to change unintentionally as compared with that of the second overlapping region 621 or that of the third overlapping region 631, and the flow rate of the cooling air flowing through the overlapping region 69 is likely to decrease unintentionally.

In order to suppress the unintended decrease in the flow rate of the cooling air passing through the first overlapping region 611, the first through-hole 101 and the first opening 261 may have the feature A as described above, and may further have at least one of the features B, C, and D.

Since the first through-hole 101 and the first opening 261 illustrated in FIGS. 4A and 4B have the above-described features, it is easy to secure the desired flow rate of cooling air in the first opening 261 and the first through-hole 101 which are more likely to be affected by the change at the positions of the opening and the through-hole than the second opening 271 and the second through-hole 102 or the third opening 281 and the third through-hole 103.

In the first through-hole 101 illustrated in FIGS. 4A and 4B, the first through-hole 101 includes the first edge portion 101a defining the first non-overlapping region 612 positioned on the one side in the first direction Dr1, and the second edge portion 101b defining the first non-overlapping region 612 positioned on the other side in the first direction Dr1. The first opening 261 may include the third edge portion 261a defining the first non-overlapping region 612 positioned on the one side in the first direction Dr1, and the fourth edge portion 261b defining the first non-overlapping region 612 positioned on the other side in the first direction Dr1. The distance between the first edge portion 101a and the third edge portion 261a along the first direction Dr1 may be 1.0 mm or more. The distance between the second edge portion 101b and the fourth edge portion 261b along the first direction Dr1 may be 1.0 mm or more. That is, a sum of the distance between the first edge portion 101a and the third edge portion 261a along the first direction Dr1 and the distance between the second edge portion 101b and the fourth edge portion 261b along the first direction Dr1 may be 2.0 mm or more.

In general, the turbine rotor blade is manufactured by precision casting. Therefore, the position of the first opening 261 has a tolerance of, for example, about 1.0 mm to 1.5 mm in the first direction Dr1.

In the first through-hole 101 illustrated in FIGS. 4A and 4B, the distance between the first edge portion 101a and the third edge portion 261a along the first direction Dr1 and the distance between the second edge portion 101b and the fourth edge portion 261b along the first direction Dr1 are equal to or greater than the tolerance of the position of the first opening 261. Therefore, it is possible to prevent the first edge portion 101a or the second edge portion 101b of the first through-hole 101 from entering an inside of the first opening 261 when viewed from the rotor blade height direction. Accordingly, the change in the area of the first overlapping region 611 when viewed from the rotor blade height direction can be suppressed. Accordingly, even when the position of the first opening 261 and the position of the first through-hole 101 are deviated in any direction on the one side and the other side in the first direction Dr1, the decrease in the flow rate of the cooling air can be suppressed, and the desired flow rate of the cooling air can be secured.

The present disclosure is not limited to the above-described embodiments, and includes a modification of the above-described embodiments and an appropriate combination of the embodiments.

In the above-described embodiment, the first through-hole 101 and the first opening 261 have at least the feature A of the above-described features A to D. The second opening 271 and the second through-hole 102 may have the feature A as described above, and may further have at least one of the features B, C, and D. Similarly, the third opening 281 and the third through-hole 103 may have the feature A as described above, and may further have at least one of the features B, C, and D.

FIG. 6 is a schematic view when the through-hole 199 and the internal passage opening 291 are viewed from a rotor blade root side toward a tip side of a rotor blade body along the rotor blade height direction, and illustrates another example of the through-hole 199 and the internal passage opening 291. In the other example illustrated in FIG. 6, the through-hole 199 is larger than the internal passage opening 291, and the entire internal passage opening 291 is positioned in the through-hole 199 when viewed from the rotor blade height direction.

In the case where at least one set of the first through-hole 101 and the first opening 261, the second opening 271 and the second through-hole 102, or the third opening 281 and the third through-hole 103 has at least the feature A of the above-described features A to D, the other through-hole 199 may be larger than the internal passage opening 291, for example, as illustrated in FIG. 6, and the entire internal passage opening 291 may be positioned inside the through-hole 199 when viewed from the rotor blade height direction.

For example, the contents described in each embodiment are understood as follows.
(1) A turbine rotor blade 50 according to at least one embodiment of the present disclosure includes a rotor blade root 85 in which a first internal passage 26 that extends in a rotor blade height direction is formed and a first opening 261 on one end side of the first internal passage 26 is formed at a bottom portion 85a, and an adjustment member 100 which is attached to the bottom portion 85a and in which a first through-hole 101 that overlaps with the first opening 261 is formed when viewed from the rotor blade height direction. When viewed from the rotor blade height direction, the first through-hole 101 intersects with the first opening 261, and has a first overlapping region 611 that overlaps with the first opening 261, and a first non-overlapping region 612 that does not overlap with the first opening 261.

The cooling air for cooling the turbine rotor blade 50 passes through the first overlapping region 611. According to a configuration of the above-described (1), even when the deviation at the positions of the first opening 261 and the first through-hole 101 occurs, the change in the area of the first overlapping region 611 when viewed from the rotor blade height direction can be suppressed. Accordingly, even when the positional deviation of the first through-hole 101 with respect to the first opening 261 occurs, a decrease in the flow rate of the cooling air can be suppressed, and a desired flow rate of the cooling air can be secured.
(2) In some embodiments, in the configuration of the above-described (1), when viewed from the rotor blade height direction, the first through-hole 101 may be larger than the first opening 261 in a first direction Dr1. The first through-hole 101 may have the first non-overlapping region 612 on one side and the other side in the first direction Dr1.

According to a configuration of the above-described (2), since the first non-overlapping region 612 is present on the one side and the other side in the first direction Dr1, even when the position of the first opening 261 and the position of the first through-hole 101 are deviated in any direction of the one side and the other side in the first direction Dr1, the change in the area of the first overlapping region 611 when viewed from the rotor blade height direction can be suppressed. Accordingly, even when the position of the first opening 261 and the position of the first through-hole 101 are deviated in any direction on the one side and the other side in the first direction Dr1, the decrease in the flow rate of the cooling air can be suppressed, and the desired flow rate of the cooling air can be secured.
(3) In some embodiments, in the configuration of the above-described (2), when viewed from the rotor blade height direction, the first through-hole 101 may be defined by a first side 111 that extends along the first direction Dr1 and a second side 112 that is separated from the first side 111 in a second direction Dr2 intersecting with the first direction Dr1 and that is parallel to the first side 111.

According to a configuration of the above-described (3), even when the position of the first opening 261 and the position of the first through-hole 101 are deviated in any direction of the one side and the other side in the first direction Dr1, the distance between the first side 111 and the second side 112 in the first overlapping region 611 does not change. Therefore, the change in the area of the first overlapping region 611 when viewed from the rotor blade height direction can be suppressed. Accordingly, even when the position of the first opening 261 and the position of the first through-hole 101 are deviated in any direction on the one side and the other side in the first direction Dr1, the decrease in the flow rate of the cooling air can be suppressed, and the desired flow rate of the cooling air can be secured.
(4) In some embodiments, in the configuration of the above-described (2) or (3), when viewed from the rotor blade height direction, the first opening 261 may be defined by a third side 213 that extends along a second direction Dr2 intersecting with the first direction Dr1 and a fourth side 214 that is separated from the third side 213 in the first direction Dr1 and that is parallel to the third side 213.

According to a configuration of the above-described (4), even when the position of the first opening 261 and the position of the first through-hole 101 are deviated in any direction of the one side and the other side in the second direction Dr2, the distance between the third side 213 and the fourth side 214 in the first overlapping region 611 does not change. Therefore, the change in the area of the first overlapping region 611 when viewed from the rotor blade height direction can be suppressed. Accordingly, even when the position of the first opening 261 and the position of the first through-hole 101 are deviated in any direction on the one side and the other side in the second direction Dr2, the decrease in the flow rate of the cooling air can be suppressed, and the desired flow rate of the cooling air can be secured.
(5) In some embodiments, in the configuration of any one of the above-described (2) to (4), the first direction Dr1 may be a lateral direction of the first opening 261 when viewed from the rotor blade height direction.

According to a configuration of the above-described (5), even when the position of the first opening 261 and the position of the first through-hole 101 are deviated in any direction on the one side and the other side in the lateral direction of the first opening 261, the desired flow rate of the cooling air can be secured.
(6) In some embodiments, in the configuration of any one of the above-described (2) to (4), the first direction Dr1 may be a longitudinal direction of the first opening 261 when viewed from the rotor blade height direction.

According to a configuration of the above-described (6), even when the position of the first opening 261 and the position of the first through-hole 101 are deviated in any direction on the one side and the other side in the longitudinal direction of the first opening 261, the desired flow rate of the cooling air can be secured.
(7) In some embodiments, in the configuration of any one of the above-described (1) to (6), in the rotor blade root 85, a second internal passage 27 that extends in the rotor blade height direction may be formed and a second opening 271 on one end side of the second internal passage 27 may be formed at the bottom portion 85a. In the adjustment member 100, a second through-hole 102 that overlaps with the second opening 271 when viewed from the rotor blade height direction may be formed. When viewed from the rotor blade height direction, the second through-hole 102 has a second overlapping region 621 that overlaps with the second opening 271.

According to a configuration of the above-described (7), the cooling air can be supplied to the second internal passage 27 different from the first internal passage 26, so that the turbine rotor blade 50 can be more cooled.
(8) In some embodiments, in the configuration of the above-described (7), the first opening 261 and the first through-hole 101 may be positioned closer to a rear edge 52 side of a rotor blade body 81 than the second opening 271 and the second through-hole 102 are.

According to a configuration of the above-described (8), since the first opening 261 and the first through-hole 101 have the configuration of any one of the above-described (1) to (6), it is easy to secure the desired flow rate of cooling air in the first opening 261 and the first through-hole 101 which are more likely to be affected by the change at the positions of the opening and the through-hole than the second opening 271 and the second through-hole 102.
(9) In some embodiments, in the configuration of the above-described (7) or (8), a value (S1a/S1b) obtained by dividing an area (S1a) of the first overlapping region 611 when viewed from the rotor blade height direction by an area (S1b) of the first opening 261 when viewed from the rotor blade height direction may be larger than a value (S2a/S2b) obtained by dividing an area (S2a) of the second overlapping region 621 when viewed from the rotor blade height direction by an area (S2b) of the second opening 271 when viewed from the rotor blade height direction.

In a configuration of the above-described (9), the value (S1a/S1b) obtained by dividing the area (S1a) of the first overlapping region 611 by the area (Sb) of the first opening 261 is larger than the value (S2a/S2b) obtained by dividing the area (S2a) of the second overlapping region 621 by the area (S2b) of the second opening 271. Therefore, the area (S1a) of the first overlapping region 611 is likely to change unintentionally as compared with that of the second overlapping region 621, and the flow rate of the cooling air flowing through the overlapping region 69 is likely to decrease unintentionally.

According to a configuration of the above-described (9), since the first opening 261 and the first through-hole 101 have the configuration of any one of the above-described (1) to (6), it is easy to secure the desired flow rate of cooling air in the first opening 261 and the first through-hole 101 which are more likely to be affected by the change at the positions of the opening and the through-hole than the second opening 271 and the second through-hole 102.
(10) In some embodiments, in the configuration of any one of the above-described (7) to (9), in the rotor blade root 85, a third internal passage 28 that extends in the rotor blade height direction may be formed and a third opening 281 on one end side of the third internal passage 28 may be formed at the bottom portion 85a. In the adjustment member 100, a third through-hole 103 that overlaps with the third opening 281 when viewed from the rotor blade height direction may be formed. When viewed from the rotor blade height direction, the third through-hole 103 has a third overlapping region 631 that overlaps with the third opening 281.

According to a configuration of the above-described (10), the cooling medium can be supplied to the third internal passage 28 different from the first internal passage 26 and the second internal passage 27, so that the turbine rotor blade 50 can be more cooled.
(11) In some embodiments, in the configuration of the above-described (10), the first opening 261 and the first through-hole 101 may be positioned closer to a rear edge 52 side of a rotor blade body 81 than the second opening 271, the second through-hole 102, the third opening 281, and the third through-hole 103 are.

According to a configuration of the above-described (11), since the first opening 261 and the first through-hole 101 have the configuration of any one of the above-described (1) to (6), it is easy to secure the desired flow rate of cooling air in the first opening 261 and the first through-hole 101 which are more likely to be affected by the change at the positions of the opening and the through-hole than the second opening 271 and the second through-hole 102 or the third opening 281 and the third through-hole 103.
(12) In some embodiments, in the configuration of the above-described (10) or (11), a value (S1a/S1b) obtained by dividing an area (S1a) of the first overlapping region 611 when viewed from the rotor blade height direction by an area (S1b) of the first opening 261 when viewed from the rotor blade height direction may be larger than a value (S2a/S2b) obtained by dividing an area (S2a) of the second overlapping region 621 when viewed from the rotor blade height direction by an area (S2b) of the second opening 271 when viewed from the rotor blade height direction and a value (S3a/S3b) obtained by dividing an area (S3a) of the third overlapping region 631 when viewed from the rotor blade height direction by an area (S3b) of the third opening 281 when viewed from the rotor blade height direction.

According to a configuration of the above-described (12), since the first opening 261 and the first through-hole 101 have the configuration of any one of the above-described (1) to (6), it is easy to secure the desired flow rate of cooling air in the first opening 261 and the first through-hole 101 which are more likely to be affected by the change at the positions of the opening and the through-hole than the second opening 271 and the second through-hole 102 or the third opening 281 and the third through-hole 103.
(13) In some embodiments, in the configuration of the above-described (2), the first through-hole may have a first edge portion defining the first non-overlapping region positioned on the one side in the first direction, and a second edge portion defining the first non-overlapping region positioned on the other side in the first direction. The first opening may have a third edge portion defining the first non-overlapping region positioned on the one side in the first direction, and a fourth edge portion defining the first non-overlapping region positioned on the other side in the first direction. A sum of a distance between the first edge portion and the third edge portion along the first direction and a distance between the second edge portion and the fourth edge portion along the first direction may be 2.0 mm or more.

According to a configuration of the above-described (13), the distance between the first edge portion 101a and the third edge portion 261a along the first direction Dr1 and the distance between the second edge portion 101b and the fourth edge portion 261b along the first direction Dr1 are equal to or greater than the tolerance of the position of the first opening 261. Therefore, it is possible to prevent the first edge portion 101a or the second edge portion 101b of the first through-hole 101 from entering the inside of the first opening 261 when viewed from the rotor blade height direction. Accordingly, the change in the area of the first overlapping region 611 when viewed from the rotor blade height direction can be suppressed. Accordingly, even when the position of the first opening 261 and the position of the first through-hole 101 are deviated in any direction on the one side and the other side in the first direction Dr1, the decrease in the flow rate of the cooling air can be suppressed, and the desired flow rate of the cooling air can be secured.

### REFERENCE SIGNS LIST

26: first internal passage
27: second internal passage
28: third internal passage
50: turbine rotor blade
51: front edge
52: rear edge
81: rotor blade body
85: rotor blade root portion (rotor blade root)
85a: bottom portion
101: first through-hole
101a: first edge portion
101b: second edge portion
102: second through-hole
103: third through-hole
111: first side
112: second side
213: third side
214: fourth side
261: first opening
261a: third edge portion
261b: fourth edge portion
271: second opening
281: third opening
611: first overlapping region
612: first non-overlapping region
621: second overlapping region
631: third overlapping region

1-13. (canceled)

14. A turbine rotor blade comprising:
a rotor blade root in which a first internal passage that extends in a rotor blade height direction is formed and a first opening on one end side of the first internal passage is formed at a bottom portion; and
an adjustment member which is attached to the bottom portion and in which a first through-hole that overlaps with the first opening is formed when viewed from the rotor blade height direction,
wherein, when viewed from the rotor blade height direction, the first through-hole intersects with the first opening, and has a first overlapping region that overlaps with the first opening, and a first non-overlapping region that does not overlap with the first opening, and
when viewed from the rotor blade height direction, the first through-hole is larger than the first opening in a first direction, and has the first non-overlapping region on one side and the other side in the first direction.

15. The turbine rotor blade according to claim 14,
wherein, when viewed from the rotor blade height direction, the first through-hole is defined by a first side that extends along the first direction and a second side that is separated from the first side in a second direction intersecting with the first direction and that is parallel to the first side.

16. The turbine rotor blade according to claim 15,
wherein, when viewed from the rotor blade height direction, the first opening is defined by a third side that extends along a second direction intersecting with the first direction and a fourth side that is separated from the third side in the first direction and that is parallel to the third side.

17. The turbine rotor blade according to claim 14,
wherein the first direction is a lateral direction of the first opening when viewed from the rotor blade height direction.

18. The turbine rotor blade according to claim 14,
wherein the first direction is a longitudinal direction of the first opening when viewed from the rotor blade height direction.

19. The turbine rotor blade according to claim 14,
wherein, in the rotor blade root, a second internal passage that extends in the rotor blade height direction is formed and a second opening on one end side of the second internal passage is formed at the bottom portion,
in the adjustment member, a second through-hole that overlaps with the second opening when viewed from the rotor blade height direction is formed, and
when viewed from the rotor blade height direction, the second through-hole has a second overlapping region that overlaps with the second opening.

20. The turbine rotor blade according to claim 19,
wherein the first opening and the first through-hole are positioned closer to a rear edge side of a rotor blade body than the second opening and the second through-hole are.

21. The turbine rotor blade according to claim 19,
wherein a value (S1a/S1b) obtained by dividing an area (S1a) of the first overlapping region when viewed from the rotor blade height direction by an area (S1b) of the first opening when viewed from the rotor blade height direction is larger than a value (S2a/S2b) obtained by dividing an area (S2a) of the second overlapping region when viewed from the rotor blade height direction by an area (S2b) of the second opening when viewed from the rotor blade height direction.

22. The turbine rotor blade according to claim 19,
wherein, in the rotor blade root, a third internal passage that extends in the rotor blade height direction is formed and a third opening on one end side of the third internal passage is formed at the bottom portion,
in the adjustment member, a third through-hole that overlaps with the third opening when viewed from the rotor blade height direction is formed, and
when viewed from the rotor blade height direction, the third through-hole has a third overlapping region that overlaps with the third opening.

23. The turbine rotor blade according to claim 22,
wherein the first opening and the first through-hole are positioned closer to a rear edge side of a rotor blade body than the second opening, the second through-hole, the third opening, and the third through-hole are.

24. The turbine rotor blade according to claim 22,
wherein a value (S1a/S1b) obtained by dividing an area (S1a) of the first overlapping region when viewed from the rotor blade height direction by an area (S1b) of the first opening when viewed from the rotor blade height direction is larger than a value (S2a/S2b) obtained by dividing an area (S2a) of the second overlapping region when viewed from the rotor blade height direction by an area (S2b) of the second opening when viewed from the rotor blade height direction and a value (S3a/S3b) obtained by dividing an area (S3a) of the third overlapping region when viewed from the rotor blade height direction by an area (S3b) of the third opening when viewed from the rotor blade height direction.

25. The turbine rotor blade according to claim 14,
wherein the first through-hole has a first edge portion defining the first non-overlapping region positioned on the one side in the first direction, and a second edge portion defining the first non-overlapping region positioned on the other side in the first direction,
the first opening has a third edge portion defining the first non-overlapping region positioned on the one side in the first direction, and a fourth edge portion defining the first non-overlapping region positioned on the other side in the first direction, and
a sum of a distance between the first edge portion and the third edge portion along the first direction and a distance between the second edge portion and the fourth edge portion along the first direction is 2.0 mm or more.
